(19) United States
(12) Patent Application Publication
(10) Pub. No.: US 2024/0031695 A1
(43) Pub. Date: Jan. 25, 2024

(54) IMAGE CAPTURING DEVICE, REFERENCE IMAGE GENERATION METHOD, AND COMPUTER PROGRAM PRODUCT

(71) Applicant: PFU LIMITED, Ishikawa (JP)

(72) Inventor: Akira ORITO, Ishikawa (JP)

(21) Appl. No.: 18/209,145

(22) Filed: Jun. 13, 2023

(30) Foreign Application Priority Data
Jul. 20, 2022 (JP) 2022-115277

(51) Int. Cl. H04N 25/61; H04N 23/51; H04N 23/80

(52) U.S. Cl. CPC H04N 25/61; H04N 23/51; H04N 23/80

(57) ABSTRACT

In an image capturing device, an image-capturing target medium is placed on a mount. An image capturing unit is disposed to face the mount and captures an image of the image-capturing target medium, which is placed on the mount, from above of the image-capturing target medium. A memory unit stores a third reference image that is obtained when a first reference image, which is a reference image captured by the image capturing unit, is corrected using a second reference image, which is estimated to be captured by the image capturing unit under the assumption that a reference medium is present over the entire image capturing range of the image capturing unit. A correcting unit corrects the gradation of the image of the image-capturing target medium, which is captured by the image capturing unit, based on the gradation of the third reference image.

### CROSS-REFERENCE TO RELATED APPLICATION

This application is based upon and claims the benefit of priority of the prior Japanese Patent Application No. 2022-115277, filed on Jul. 20, 2022, the entire contents of which are incorporated herein by reference.

### FIELD

The present disclosure relates to an image capturing device, a reference image generation method, and a computer program product.

### BACKGROUND

An image capturing device is known that captures an image of a page (hereinafter, called a “page image”) of a booklet medium such as a passport, and accordingly performs personal identification. Moreover, an image capturing device is known that performs shading correction with respect to a captured page image. Furthermore, an image capturing device is known in which, since a page image is captured from above of the booklet medium, in order to prevent the booklet medium from coming off at the time of capturing a page image and hence to prevent distortion of the page image, a guide member is included that has a function of holding the booklet medium from above.

The shading correction is performed with reference to such an image which is captured by the image capturing device when no booklet medium is present within the image capturing range of the image capturing device. The image that serves as the reference for shading correction (hereinafter, called a “reference image”) is normally a white image or a black image.

On the other hand, in the region in which a guide member is present (hereinafter, called a “guide member existence region”), it is difficult to capture a reference image due to the shielding attributed to the guide member. Hence, in a page image, it is difficult to perform shading correction with respect to the region that is shielded by the guide member (hereinafter, called a “shielded region”).

In that regard, in the application concerned, a technology is proposed that enables accurate shading correction with respect to an image captured by an image capturing device.

### SUMMARY

According to an aspect of an embodiment, an image capturing device includes a mount on which an medium is placed, an imager disposed to face the mount and configured to capture an image of the medium, which is placed on the mount, from above of the medium, a memory configured to store a third reference image which is obtained when a first reference image, which is a reference image captured by the imager, is corrected using a second reference image, which is estimated to be captured by the imager under assumption that a reference medium is present over entire image capturing range of the imager, and a processor configured to correct gradation of the image of the medium, which is captured by the imager, based on gradation of the third reference image.

### BRIEF DESCRIPTION OF DRAWINGS

FIG. 1 is a diagram illustrating an exemplary exterior view of an image capturing device according to the application concerned;

FIG. 2 is a perspective view illustrating an example of a mount, a left guide member, and a right guide member according to the application concerned;

FIG. 3 is an exemplary perspective view of the left guide member according to the application concerned;

FIGS. 4 and 5 are exemplary front sectional views of the mount, the left guide member, and the right guide member according to the application concerned;

FIG. 6 is a diagram illustrating an example of a passport according to the application concerned;

FIG. 7 is an expanded perspective views of the binding portion of an ICAO passport according to the application concerned;

FIG. 8 a planar view illustrating a page of the ICAO passport according to the application concerned;

FIG. 9 is an expanded perspective view of the binding portion of a German passport according to the application concerned;

FIG. 10 is a perspective view of the ICAO passport when the front end on the far side of a thin portion makes contact with a left connection portion;

FIG. 11 is a perspective view of the ICAO passport when the front end of the thin portion has moved closer to a thin portion facing region according to the application concerned;

FIG. 12 is a perspective view of the ICAO passport when the thin portion is placed in between a left holding portion and a mount main body according to the application concerned;

FIG. 13 is a perspective cross-sectional view of the ICAO passport when appropriately placed in the mount main body according to the application concerned;

FIG. 14 is a perspective cross-sectional view of a thick portion and a right-side side guide portion when the ICAO passport is appropriately placed in the mount main body according to the application concerned;

FIG. 15 is an expanded perspective cross-sectional view of the thin portion when the ICAO passport is appropriately placed in the mount main body according to the application concerned;

FIG. 16 is a perspective cross-sectional view of the thin portion when the ICAO passport is appropriately placed in the mount main body according to the application concerned;

FIG. 17 is a diagram illustrating an image that is captured by an image capturing unit when the ICAO passport is appropriately placed in the mount main body according to the application concerned;

FIG. 18 is a perspective cross-sectional view of the German passport when appropriately placed in the mount main body according to the application concerned;

FIG. 19 is a perspective cross-sectional view of the thick portion and the right-side side guide portion when the German passport is appropriately placed in the mount main body according to the application concerned;

FIG. 20 is an expanded perspective cross-sectional view of the thin portion when the German passport is appropriately placed in the mount main body according to the application concerned;

FIG. 21 is a perspective cross-sectional view of the thin portion when the German passport is appropriately placed in the mount main body according to the application concerned;

FIG. 22 is a diagram illustrating an exemplary configuration of an image processing system according to the application concerned;

FIG. 23 is a diagram illustrating an exemplary configuration of the image capturing device according to the application concerned;

FIGS. 24 to 30 are diagrams for explaining an example of generating an extended reference image according to the application concerned; and

FIGS. 31 and 32 are diagrams for explaining as example of shading correction performed according to the application concerned.

### DESCRIPTION OF EMBODIMENT

An exemplary embodiment of the application concerned is described below with reference to the accompanying drawings.

In the drawings, identical configurations are referred to by the same reference numerals.

### Structure of Image Capturing Device

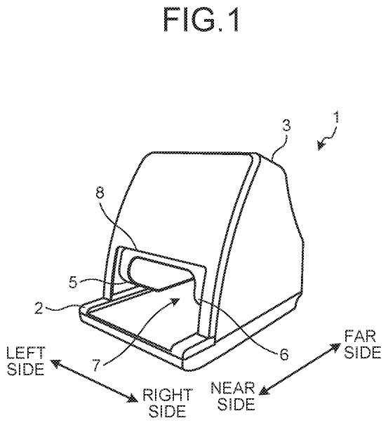

FIG. 1 is a diagram illustrating an exemplary exterior view of an image capturing device according to the application concerned. In FIG. 1, an image capturing device 1 includes a mount 2, a housing 3, a left guide member 5, and a right guide member 6. The housing 3 is made of such a material through which the light does not easily penetrate; and has a box-like shape. The housing 3 is placed on the mount 2 and is fixed to the mount 2. Inside the housing 3, an internal space 7 is formed that is enclosed by the mount 2 and the housing 3. On the near side of the housing 3, an opening 8 is formed. Thus, the internal space 7 is connected to the outside via the opening 8.

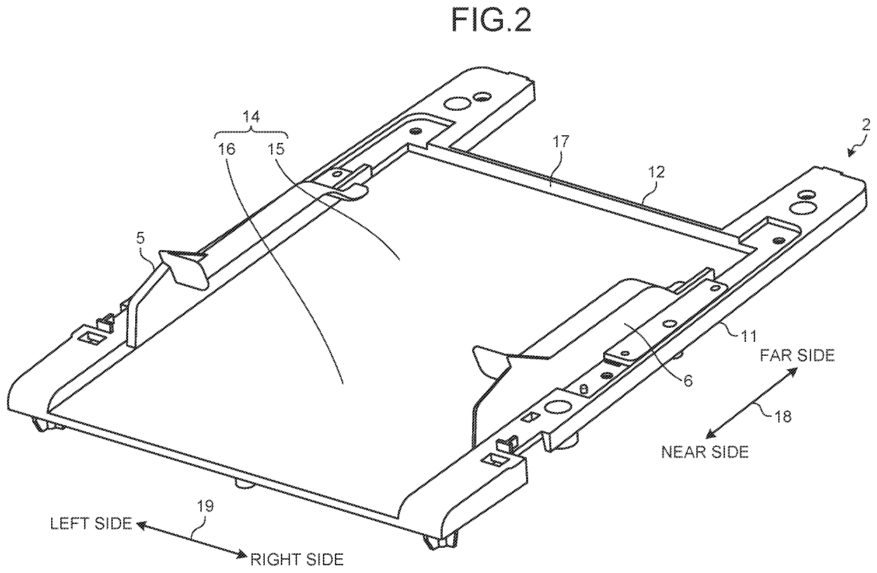

FIG. 2 is a perspective view illustrating an example of the mount, the left guide member, and the right guide member according to the application concerned. The mount 2 includes a mount main body 11 and an abutting portion 12. The mount main body 11 is formed to have a plate-like shape. On the mount main body 11, a flat mount surface 14 is formed that includes a thin portion facing region 15 and a thick portion facing region 16. The thin portion facing region 15 and the thick portion facing region 16 are arranged in an insertion direction 18 that is parallel to the plane along which the mount surface 14 is aligned. Moreover, the thick portion facing region 16 is placed more on the near side as compared to the thin portion facing region 15. With respect to the mount main body 11, the housing 3 is placed in such a way that the thin portion facing region 15 is placed inside the internal space 7 and that some part of the thick portion facing region 16 is placed on the outside of the housing 3 via the opening 8.

The abutting portion 12 is formed to have a belt-like shape. Moreover, in the abutting portion 12, a flat abutting surface 17 is formed. The abutting portion 12 is placed on the far side of the mount surface 14 in such a was that the plane along which the abutting surface 17 is aligned is perpendicular to the insertion direction 18 and that the abutting surface 17 is oriented toward the near side. The abutting portion 12 is formed in an integrated manner with the mount main body 11 and is fixed to the mount main body 11.

The left guide member 5 is placed at the left end of a width direction 19 of the mount surface 14. The right guide member 6 is placed at the right end of the width direction 19 of the mount surface 14. The width direction 19 is parallel to the plane along which the mount surface 14 is aligned, and is perpendicular to the insertion direction 18.

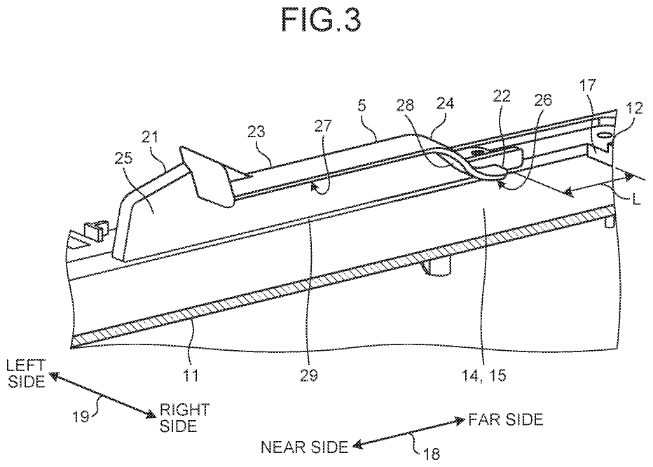

FIG. 3 is an exemplary perspective view of the left guide member according to the application concerned. The left guide member 5 includes a left-side side guide portion 21, a left holding portion 22, a top left guide portion 23, and a left connection portion 24. In the left-side side guide portion 21, a flat left-side side guide surface 25 is formed. The left-side side guide portion 21 is placed at the left bottom end of the internal space 7 in such a way that the left-side side guide surface 25 is oriented toward the right side and the plane along which the left-side side guide surface 25 is aligned is perpendicular to the width direction 19. The left-side side guide portion 21 is fixed to the mount main body 11.

The left holding portion 22 is formed to have a plate-lite shape. In the left holding portion 22, a flat left holding surface 26 is formed. The left holding portion 22 is placed above the thin portion facing region 15 in such a way that the left holding surface 26 faces the thin portion facing region 15 and is aligned along another plane parallel to the plane along which the mount surface 14 is aligned. Moreover, the left holding portion 22 is separated from the abutting surface 17 on the near side in such a way that the distance between the far-side end of the left holding portion 22 and the abutting surface 17 of the abutting portion 12 is equal to a length L. Furthermore, the left holding portion 22 is placed on the left side of the thin portion facing region 15 of the mount surface 14. Herein, the left holding portion 22 is formed in an integrated manner with the left-side side guide portion 21 and protrudes from the left-side side guide surface 25. The left holding portion 22 is fixed to the left-side side guide portion 21, and in turn is fixed to the mount main body 11 via the left-side side guide portion 21.

The top left guide portion 23 is formed to have a flat belt-like shape. In the top left guide portion 23, a flat top left guide surface 27 is formed. The top left guide portion 23 is placed on the near side of the left holding portion 22 in such a way that the top left guide surface 27 faces the thin portion facing region 15 and is aligned along another plane that is parallel to the plane along which the mount surface 14 is aligned. Moreover, the top left guide portion 23 is placed at an upper level than the left holding portion 22, so that the distance between a top left guide surface 27 and the thin portion facing region 15 is greater than the distance between the left holding surface 26 and the thin portion facing region 15. The near-side end of the top left guide portion 23 is placed near the opening 8. The top left guide portion 23 is formed in an integrated manner with the left-side side guide portion 21 and protrudes from the left-side side guide surface 25. Moreover, the top left guide portion 23 is fixed to the left-side side guide portion 21, and is in turn fixed to the mount main body 11 via the left-side side guide portion 21.

The left connection portion 24 is formed to have a curved belt-like shape. The left connection portion 24 is placed in between the left holding portion 22 and the top left guide portion 23 in such a way that the far-side end of the left connection portion 24 gets connected to the near-side end of the left holding portion 22 and that the near-side end of the left connection portion 24 gets connected to the far-side end of the top left guide portion 23. In the left connection portion 24, a left curved surface 28 is formed. One end of the left curved surface 28 is adjacent to the left holding surface 26, and the other end of the left curved surface 28 is adjacent to the top left guide surface 27. Moreover, the left curved surface 28 is formed in such a way that, as the distance from the left holding portion 22 increases, the distance between the left curved surface 28 and the mount surface 14 monotonically increases. Furthermore, the left curved surface 28 is formed to have a gentle curved surface so as to ensure that neither the boundary between the left curved surface 28 and the left holding surface 26 nor the boundary between the left curved surface 28 and The top left guide surface 27 becomes angular. The left connection portion 24 is formed in an integrated manner with the left-side side guide portion 21 and protrudes from the left-side side guide surface 25. Moreover, the left connection portion 24 is fixed to the left-side side guide portion 21, and in turn is fixed to the mount main body 11 via the left-side side guide portion 21.

In the left guide member 5, the lower end of the left-side side guide portion 21 is separated from the mount surface 14, and that end of the left-side side guide portion 21 which is closer to the mount surface 14 further has a left front cover slit 29 formed therein. The left front-cover slit 29 is formed to be recessed from the left-side side guide surface 25.

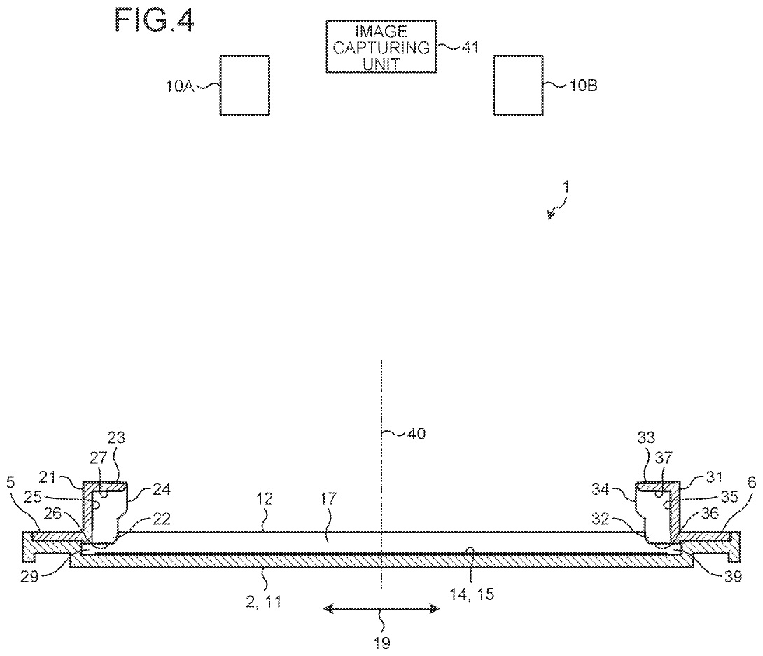

FIGS. 4 and 5 are exemplary front sectional views of the mount, the left guide member, and the right guide member according to the application concerned.

With reference to FIG. 4, the right guide member 6 and the left guide member 5 are formed in a mirror symmetry. The right guide member 6 includes a right-side side guide portion 31, a right holding portion 32, a top right guide portion 33, and a right connection portion 34. In the right-side side guide portion 31, a right-side side guide surface 35 is formed. In the right holding portion 32, a right holding surface 36 is formed. In the top right guide portion 33, a top right guide surface 37 is formed. In the right connection portion 34, a right curved surface 38 is formed.

The right guide member 6 is placed in such a way that the right-side side guide surface 35 faces the left-side side guide surface 25. That is, the right guide member 6 is placed to be symmetrical with the left guide member 5 with respect to a mirror symmetry plane 40 that is perpendicular to the width direction 19. Moreover, the right guide member 6 is fixed to the mount main body 11 of the mount 2. The mirror symmetry plane 40 is perpendicular to the width direction 19. In the right guide member 6, that end of the right-side side guide portion 31 which is closer to the mount surface 14 further has a right front-cover slit 39 formed therein. The right front-cover slit 39 is formed to be recessed from the right-side side guide surface 35.

Thus, the left holding portion 22 and the right holding portion 32 are placed in between she mount 2 and an image capturing unit 41; and an image-capturing target medium that is placed on the mount 2 is held toward the mount by the left holding portion 22 and she right holding portion 32. Hence, the left guide member 5, which includes the left holding portion 22, and the right guide member 6, which includes the right holding portion 32, cover some part of the top surface of the image-capturing target medium from above of the image-capturing target medium. Meanwhile, the left-side side guide portion 21 and the right-side side guide portion 31 are disposed to remain upright with respect to the mount 2.

The image capturing device 1 further includes the image capturing unit 41, a left illumination 10A, and a right illumination 10B. The image capturing unit 41 is made of a camera that captures an image of the image-capturing target medium. Examples of the left illumination 10A and the right illumination 10B include LED illumination (LED stands for Light Emitting Diode). The image capturing unit 41 is placed above the thin portion facing region 15 in the internal space 7, and intersects with the mirror symmetry plane 40. That is, the image capturing unit 41 is disposed to face the mount 2, and captures an image of the image-capturing target medium, which is placed on the mount 2, from above of the image-capturing target medium. The left illumination 10A and the right illumination 10B are placed inside the internal space 7 and above the thin portion facing region 15, and are placed to be mutually symmetrical with respect to the mirror symmetry plane 40. The image capturing unit 41, the left illumination 10A, and the right illumination 10B are fixed to the housing 3, and in turn are fixed to the mount 2 via the housing 3. Moreover, the image capturing unit 41 is oriented toward the thin portion facing region 15 in such a way that an image of the image-capturing target medium, which is placed in the mount main body 11 and close to the thin portion facing region 15, is captured. In the state in which the left illumination 10A or the right illumination 10B is turned on, the image capturing unit 41 captures an image of the image-capturing target medium.

In FIG. 5, the thin portion facing region 15 includes a left non-image-capturing region 42 and a right non-image-capturing region 43.

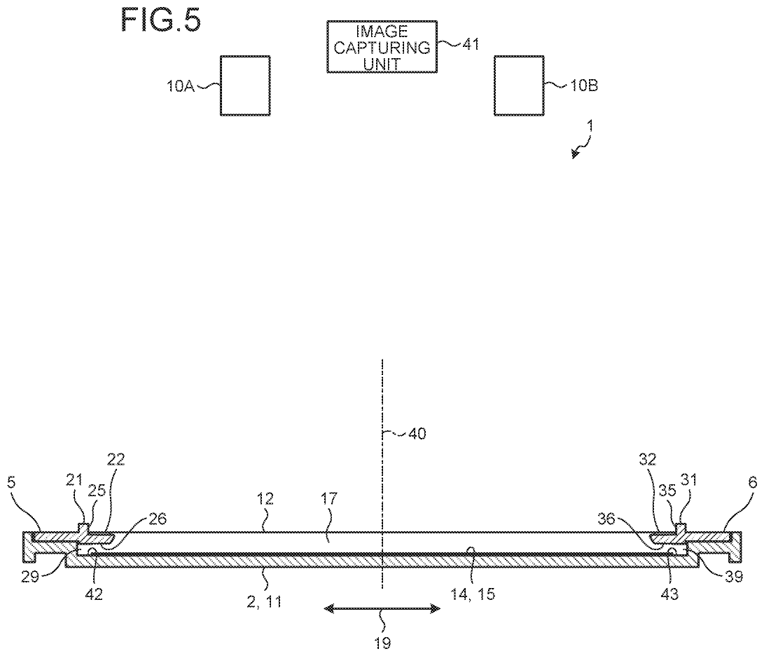

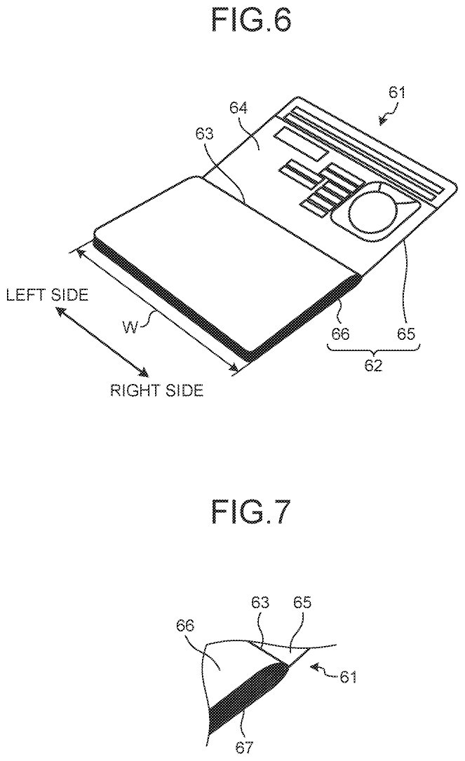

For example, the image capturing device 1 is used to capture an image of a predetermined page of a passport. A passport represents an example of a booklet medium whose image is to be captured using the image capturing device 1. FIG. 6 is a diagram illustrating an example of a passport according to the application concerned. In FIG. 6, an ICAO passport is illustrated as an example of a passport. An ICAO passport 61 is made of a booklet that is book-bound according to the specifications set by the International Civil Aviation Organization (ICAO). In the ICAO passport 61, a plurality of sheets 62 is bound in a binding portion 63, which is formed in a linear manner. In the ICAO passport 61, a page 64 is formed. The ICAO passport 61 is formed in such a way that the page 64 is not exposed when the ICAO passport 61 is in the closed state. When the ICAO passport 61 is opened to expose the page 64, the sheets 62 get divided into a thin portion 65 and a thick portion 66. The thin portion 65 is made of one of the plurality of sheets 62. The thick portion 66 is made of a plurality of sheets 62, except for the sheet 62 constituting the thin portion 65. The thick portion 66 is bonded to the thin portion 65 via the binding portion 63. The page 64 is formed in the thin portion 65. Then the ICAO passport 61 is sandwiched between the two planes perpendicular to the straight line along which the binding portion 63 is aligned, the width of the ICAO passport 61 is equal to the length of the two planes, that is, equal to the width W.

FIG. 7 is an expanded perspective view of the binding portion of an ICAO passport according to the application concerned. In FIG. 7, the thickness of the thick portion 66 is Greater than the thickness of the thin portion 65. In the thick portion 66, a right end face 67 is formed along the plane that is perpendicular to the straight line along which the binding portion 63 is aligned. On the opposite side to the side on which the right end face 67 of the thick portion 66 is formed, a left end face is formed that is oriented in the opposite direction to the direction in which the right end face 67 is oriented. The plane along which the left end face is aligned is parallel to the plane along which the right end face 67 is aligned.

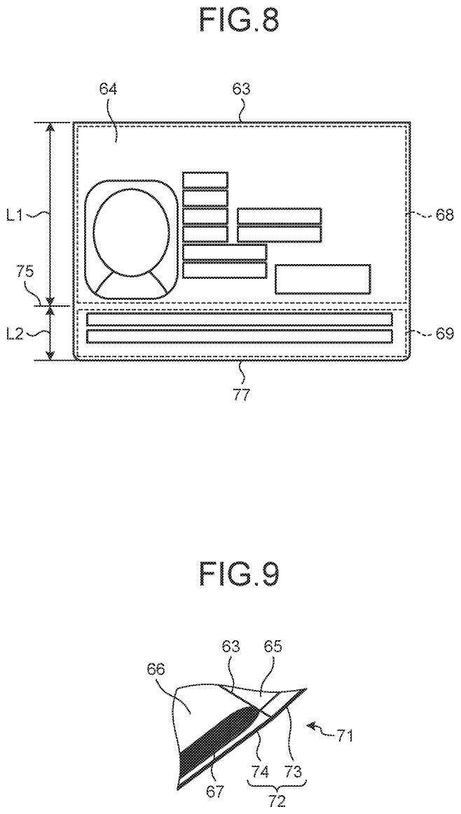

FIG. 8 is a planar view illustrating a page of the ICAO passport according to the application concerned. The page 64 includes a visual inspection zone (VIZ) 68 and a machine readable zone (MRZ) 69. In the VIZ 68, character strings are written that indicate the information related to the person who is to be identified using the ICAO passport 61. Moreover, in the VIZ 68, a photograph of the person to be identified using the ICAO passport 61 is also provided. In the MRZ 69 too, character strings are written. The MRZ 69 is placed on the far side from the binding portion 63 of the VIZ 68. The length of the VIZ 68 is equal to the distance between a boundary line 75, across which the MRZ 69 and the VIZ 68 are placed adjacent to each other, and the binding portion 63. That is, the length of the VIZ 68 is equal to a length L1. The length of the MRZ 69 is equal to the distance between a front end 77, which is on the opposite side of the binding portion 63 in the thin portion 65, and the boundary line 75. That is, the length of the MRZ 69 is equal to a length L2. Herein, the length L2 of the MRZ 69 is shorter than the length L1 of the VIZ 68.

Meanwhile, apart from an ab ICAO passport, the types of a passport also include a German passport issued in Germany in or before the year 2017. FIG. 9 is an expanded perspective view of the binding portion of a German passport according to the application concerned. In FIG. 9, a German passport 71 is formed when a front cover 72 is added to the ICAO passport 61 explained above. Thus, except for the front cover 72, the German passport 71 is same as the ICAO passport 61. That is, when the German passport 71 is opened to expose the page 64, the thin portion 65 and the thick portion 66 are formed in the German passport 71 in an identical manner to the ICAO passport 61.

The front cover 72 includes a thin-portion-side front cover 73 and a thick-portion-side front cover 74. When the German passport 71 is opened to expose the page 64, the thin-portion-side front cover 73 gets aligned along the thin portion 65. The thin-portion-side front cover 73 is larger than the thin portion 65, and the margins of the thin-portion-side front cover 73 protrude to the outside from the margins of the thin portion 65. When the German passport 71 is opened to expose the page 64, the thick-portion-side front cover 74 gets aligned along the thick portion 66. The thick-portion-side front cover 74 is larger than the thick portion 66, and the margins of the thick-portion-side front cover 74 protrude to the outside from the margins of the thin portion 65. That is, one margin of the thick-portion-side front cover 74 protrudes to the outside from the plane along which the right end face 67 is aligned; and, in an identical manner, the other margin of the thick-portion-side front cover 74 protrudes to the outside from the plane along which the left face end is aligned.

The left guide member 5 of the image capturing device 1 is placed in such a way that the length L between the far-side end of the left holding portion 22 and the abutting surface 17 of the abutting portion 12 becomes either equal to or slightly longer than the length L2 of the MRZ 69. The right guide member 6 is placed in such a way that the distance between the far-side end of the right holding portion 32 and the abutting surface 17 of the abutting portion 12 becomes either equal to or slightly longer than the length L2. The image capturing device 1 is formed in such a way that the distance between the left-side side guide surface 25 and the right-side side guide surface 35 becomes either equal to or slightly longer than the width W of the passport. Moreover, the image capturing device 1 is formed in such a way that the width of the left front-cover slit 29 is greater than the thickness of the front cover 72 and is smaller than the thickness of the thick portion 66. Furthermore, the image capturing device 1 is formed in such a way that the depth of the left front-cover slit 29 is greater than the length of protrusion of the front cover 72 from the left end face. Moreover, the image capturing device 1 is formed in such a way that the width of the right front-cover slit 39 is greater than the thickness of the front cover 72 and is smaller than the thickness of the thick portion 66. Furthermore, the image capturing device 1 is formed in such a way that the depth of the right front-cover slit 39 is greater than the length of protrusion of the front cover 72 from the right end face 67.

### Placement of Passport in Image Capturing Device

When a page image of the page 64 of the ICAO passport 61 is to be captured using the image capturing device 1, the user opens the ICAO passport 61 in such a way that the page 64 is facing upward. Moreover, the user turns the this portion 65 toward the far side of the image capturing device 1 so that the thin portion 65 is placed on the far side of the thick portion 66, and inserts the thin portion 65 into the image capturing device 1 through the opening 8. Furthermore, the user places the thin portion 65 in such a way that the thin portion 65 is positioned in between the top left guide portion 23 and the mount main body 11 and in between the top right guide portion 33 and the mount main body 11. After the thin portion 65 is positioned in between the top left guide portion 23 and the mount main body 11 and in between the top right guide portion 33 and the mount main body 11, the user moves the ICAO passport 61 to the far side.

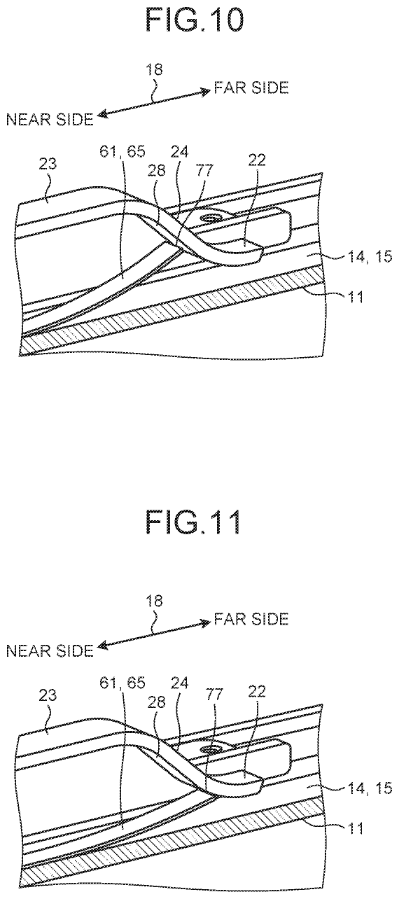

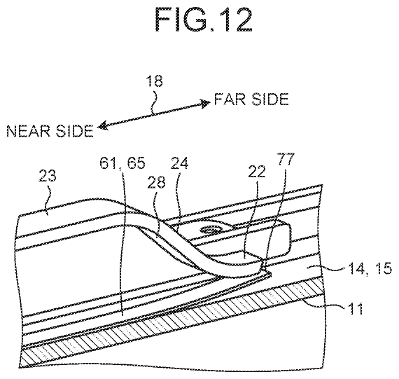

After the thin portion 65 is placed in between the top left guide portion 23 and the mount main body 11, when the ICAO passport 61 is moved toward the far side, the left portion of the front end 77 on the far side of the thin portion 65 makes contact with the left connection portion 24. FIG. 10 is a perspective view of the ICAO passport when the front end on the far side of the thin portion makes contact with the left connection portion. After the front end 77 of the thin portion 65 has made contact with the left connection portion 24, when the ICAO passport 61 is further moved toward the far side, the front end 77 moves along the left curved surface 28 and gets close to the thin portion facing region 15 of the mount surface 14 as illustrated in FIG. 11. FIG. 11 is a perspective view of the ICAO passport when the front end of the thin portion has moved closer to the thin portion facing region according to the application concerned. After the front end 77 has moved closer to the thin portion facing region 15, when the ICAO passport 61 is further moved toward the far side, the thin portion 65 gets placed in between the left holding portion 22 and the mount main body 11 in a smooth manner as illustrated in FIG. 12. FIG. 12 is a perspective view of the ICAO passport when the thin portion is placed in between the left holding portion and the mount main body according to the application concerned.

When the ICAO passport 61 is moved to the far side, in an identical manner to the left portion of the front end 77 on the far side of the thin portion 65, the right portion of the front end 77 on the far side of the thin portion 65 gets placed between the right holding portion 32 and the mount main body 11. That is, in the image capturing device 1, even the thin portion 65 is warped, it can still be guided below the left holding portion 22 and the right holding portion 32, thereby enabling achieving simplification of the user operation meant for placing the thin portion 65 below the left holding portion 22 and the right holding portion 32.

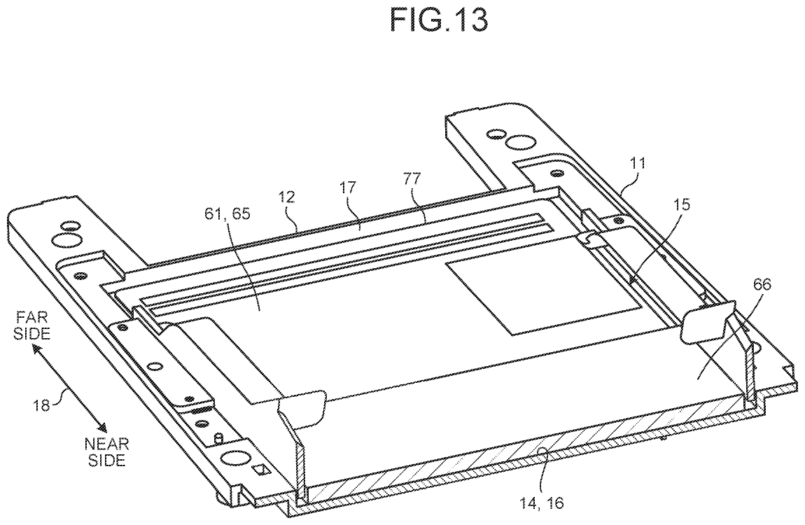

As illustrated in FIG. 13, the user further moves the ICAO passport 61 toward the far side until the front end 77 of the ICAO passport 61 lines up against the abutting surface 17 of the abutting portion 12. FIG. 13 is a perspective cross-sectional view of the ICAO passport when appropriately placed in the mount main body according to the application concerned. When the front end 77 lines up against the abutting surface 17 of the abutting portion 12, the ICAO passport 61 gets appropriately placed in the mount main body 11. Herein, the ICAO passport 61 is placed in such a way that, at the time of getting appropriately placed in the mount main body 11, the thin portion 65 faces the thin portion facing region 15 and the thick portion 66 faces the thick portion facing region 16. When the ICAO passport 61 is appropriately placed in the mount main body 11, the thin portion 65 gets placed at a predetermined image capturing position.

Moreover, when the ICAO passport 61 is appropriately placed in the mount main body 11, the thin portion 65 gets held from above by the left holding portion 22 and the right holding portion 32. That is, in the image capturing device 1, even if the thin portion 65 is warped, it gets held by the left holding portion 22 and the right holding portion 32. As a result, the thin portion 65 is prevented from significantly drawing away from the mount surface 14.

When the ICAO passport 61 is appropriately placed in the mount main body 11, the right end face 67 of the thick portion 66 of The ICAO passport 61 faces the right-side side guide surface 35 of the right-side side guide portion 31 as illustrated in FIG. 14. FIG. 14 is a perspective cross-sectional view of the thick portion and the right-side side guide portion when the ICAO passport is appropriately placed in the mount main body according to the application concerned. In case the thick portion 66 shifts to the right side, the right end face 67 makes contact with the right-side side guide surface 35, thereby restricting the ICAO passport 61 from shifting to the right side from the appropriate position. When the ICAO passport 61 is appropriately placed in the mount main body 11, the left end face of the thick portion 66 of the ICAO passport 61 faces the left-side side guide surface 25 of the left-side side guide portion 21. In case the thick portion 66 shifts to the left side from the appropriate position, the left end face makes contact with the left-side side guide surface 25, thereby restricting the ICAO passport 61 from shifting to the left side from the appropriate position. That is, in the image capturing device 1, when the ICAO passport 61 is appropriately placed in the mount main body 11, the thick portion 66 can be supported in such a way that the ICAO passport 61 does not move in the width direction 19.

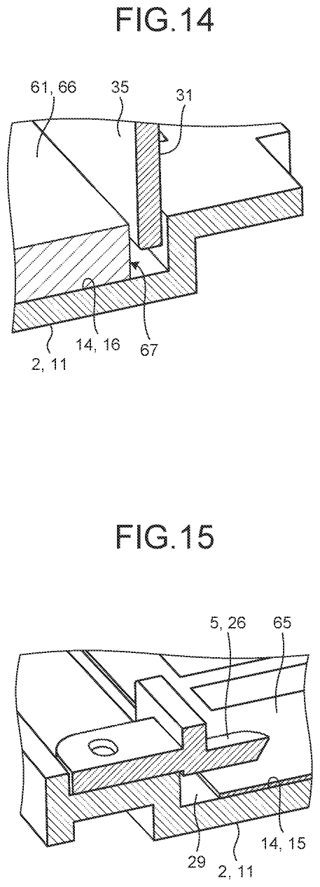

When the ICAO passport 61 is appropriately placed in the mount main body 11, the left end face of the thin portion 65 does not make contact with anything as illustrated in FIG. 15. FIG. 15 is an expanded perspective cross-sectional view of the thin portion when the ICAO passport is appropriately placed in the mount main body according to the application concerned. Moreover, when the ICAO passport 61 is appropriately placed in the mount main body 11, in an identical manner to the left end face of the thin portion 65, the right end face of the thin portion 65 does not make contact with anything. Thus, even if no member is making contact with the left end face and the right end face of the thin portion 65, since the thick portion 66 is supported in such a way that the ICAO passport 61 does not move in the width direction 19, the thin portion 65 is supported in such a way that it does riot move in the width direction 19 from the image capturing position. That is, in the image capturing device 1, when the ICAO passport 61 is appropriately placed in the mount main body 11, the ICAO passport 61 can be supported in such a way that the thin portion 65 does not move in the width direction 19 from the image capturing position.

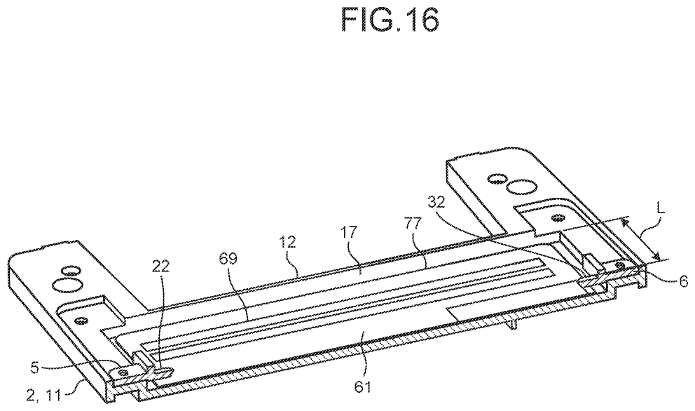

FIG. 16 is a perspective cross-sectional view of the thin portion when the ICAO passport is appropriately placed in the mount main body according to the application concerned. As illustrated in FIG. 16, when the thin portion 65 is placed at the image capturing position, since the front end 77 lines up against the abutting surface 17, the ICAO passport 61 is corrected from the inclined state to the non-inclined state, and the movement thereof is restricted to ensure no inclination.

When the thin portion 65 is placed at the image capturing position, that portion of the thin portion 65 in which the VIZ 68 remains placed gets held by the left holding portion 22 and the right holding portion 32. On the other hand, when the thin portion 65 is placed at the image capturing position, since the left holding portion 22 and the right holding portion 32 are separated from the abutting portion 12 by the length L, the MRZ 69 is not held by the left holding portion 22 and the right holding portion 32. That is, in the image capturing device 1, when the ICAO passport 61 is appropriately placed in the mount main body 11, the entire MRZ 69 can be kept exposed to ensure that it does not get partially hidden behind the left holding portion 22 and the right holding portion 32.

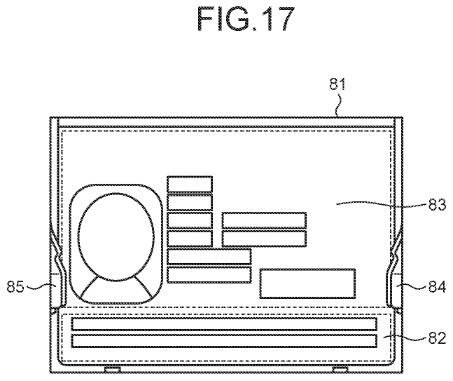

When the ICAO passport 61 is appropriately placed in the mount main body 11, the image capturing unit 41 captures a page image of the page 64 while the left illumination 10A or the right illumination 10B is turned on. In an image 81 that is captured by the image capturing unit 41 when the ICAO passport 61 is appropriately placed in the mount main body 11; an MRZ image 82, a VIZ image 83, a left guide member image 84, and a right guide member image 85 are visible as illustrated in FIG. 17. FIG, 17 is a diagram illustrating an image that is captured by the image capturing unit when the ICAO passport is appropriately placed in the mount main body according to the application concerned. In the MRZ image 82, the MRZ 69 of the page 64 is visible in entirety. That is, in the image capturing device 1, when the ICAO passport 61 is appropriately placed in the mount main body 11, since the MRZ 69 is not hidden behind the left guide member 5 and the right guide member 6, it becomes possible to capture the image 81 of the entire MRZ 69.

In the VIZ image 83, that portion of the VIZ 68 of the page 64 is visible which is not covered by the left guide member 5 and the right guide member 6. In the left guide member image 84, the left holding portion 22 and the left connection portion 24 are visible. In the right guide member image 85, the right holding portion 32 and the right connection portion 34 are visible.

Meanwhile, when a page image of the page 64 of the German passport 71 is to be captured using the image capturing device 1, in an identical manner to the case of the ICAO passport 61, the user appropriately places the German passport 71 in the mount main body 11. That is, the user opens the German passport 71 in such a way that the page 64 as facing upward, and inserts the German passport 71 into the image capturing device 1 through the opening 8 until the front end 77 of the thin portion 65 on the opposite side of the binding portion 63 makes contact with the abutting surface 17 of the abutting portion 12. When the front end of the German passport 71 lines up against the abutting surface 17 of the abutting portion 12, the German passport 71 gets appropriately placed in. the mount main body 11.

FIG. 18 is a perspective cross-sectional view of the German passport when appropriately placed in the mount main body according to the application concerned. When the German passport 71 is appropriately placed in the mount main body 11, in an identical manner to the case of the ICAO passport 61, the German passport 71 is placed in such a way that the thin portion 65 faces the thin portion facing region 15 and that the thick portion 66 faces the thick portion facing region 16. When the German passport 71 is appropriately placed in the mount main body 11, the thin portion 65 is placed at the image capturing position.

When the German passport 71 is appropriately placed in the mount main body 11, the thin portion 65 gets held from above by the left holding portion 22 and the right holding portion 32. That is, in the image capturing device 1, even if the thin portion 65 is warped, it gets held by the left holding portion 22 and the right holding portion 32. As a result, the thin portion 65 is prevented from significantly drawing away from the mount surface 14.

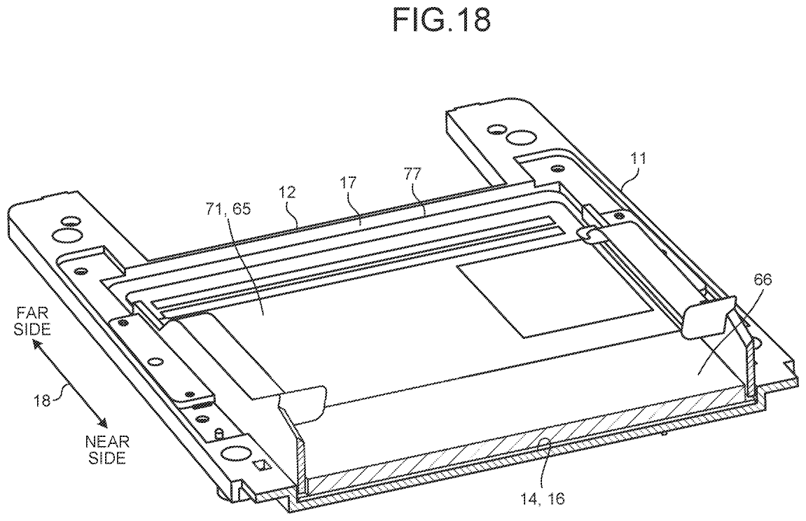

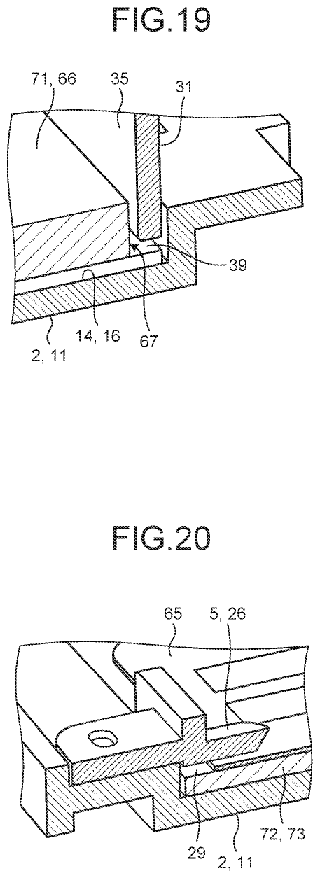

When the German passport 71 is appropriately placed in the mount main body 11, that portion of the thick-portion-side front cover 74 of the German passport 71 which protrudes from the right end face 67 is placed in the right front-cover slit 39 as illustrated in FIG. 19. FIG. 19 is a perspective cross-sectional view of the thick portion and the right-side side guide portion when the German passport is appropriately placed in the mount main body according to the application concerned. Moreover, when the German passport 71 is appropriately placed in the mount main body 11, in an identical manner to that portion of the thick-portion-side front cover 74 which protrudes from the right end face 67, that portion of the thick-portion-side front cover 74 which protrudes from the left end face is placed in the left front-cover slit 29.

When the German passport 71 is appropriately placed in the mount main body 11, the right end face 67 of the thick portion 66 of the German passport 71 faces the right-side side guide surface 35 of the right-side side guide portion 31. Moreover, when the German passport 71 is appropriately placed in the mount main body 11, in an identical manner to the right end face 67 of the thick portion 66, the left end face of the thick portion 66 of the German passport 71 faces the left-side side guide surface 25 of the left-side side guide portion 21. That is, when the German passport 71 is appropriately placed in the mount main body 11, the thick-portion-side front cover 74 does not interfere with the lining up of the left end face of the thick portion 66 against the left-side side guide surface 25. For that reason, in the image capturing device 1, when the German passport 71 is appropriately placed in the mount main body 11, the thick portion 66 can be supported in such a way that the German passport 71 does not move in the width direction 19.

When the German passport 71 is appropriately placed in the mount main body 11, that portion of the thin-portion-side front cover 73 of the German passport 71 which protrudes to the left side from the thin portion 65 is placed in the left front-cover slit 29 as illustrated in FIG. 20. FIG. 20 is an expanded perspective cross-sectional view of the thin portion when the German passport is appropriately placed in the mount main body according to the application concerned. Moreover, when the German passport 71 is appropriately placed in the mount main body 11, in an identical manner to that portion of the thin-portion-side front cover 73 which protrudes to the left side from the thin portion 65, that portion of the thin-portion-side front cover 73 of the German passport 71 which protrudes to the right side from the thin portion 65 is placed in the right front-cover slit 39. That is, in the image capturing device 1, when the German passport 71 is appropriately placed in the mount main body 11, the thin portion 65 can be appropriately placed at the image capturing position without any interference from the thin-portion-side front cover 73.

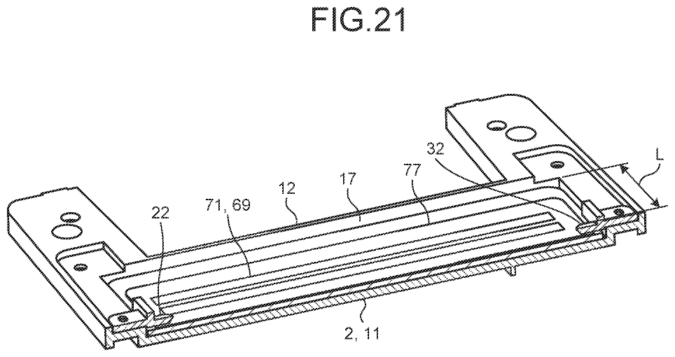

FIG. 21 is a perspective cross-sectional view of the thin portion when the German passport is appropriately placed in the mount main body according to the application concerned. As illustrated in FIG. 21, when the thin portion 65 is placed at the image capturing position, since the front end 77 lines up against the abutting surface 17, the German passport 71 is corrected from the inclined state to the non-inclined state, and the movement thereof is restricted to ensure no inclination.

When the thin portion 65 is placed at the image capturing position, that portion of the thin portion 65 in which the VIZ 68 remains placed gets held by the left holding portion 22 and the right holding portion 32. On the other hand, when the thin portion 65 is placed at the image capturing position, since the left holding portion 22 and the right holding portion 32 are separated from the abutting portion 12 by the length L, the MRZ 69 is not held by the left holding portion 22 and the right holding portion 32. That is, in the image capturing device 1, when the German passport 71 is appropriately placed in the mount main body 11, the entire MRZ 69 can be kept exposed to ensure that it does not get partially hidden behind the left holding portion 22 and the right holding portion 32.

Thus, in the image capturing device 1, even when the German passport 71 is inserted through the opening 8, the thin portion 65 is appropriately placed at the image capturing position. In the image capturing device 1, since the thin portion 65 of the German passport 71 is appropriately placed at the image capturing position, a page image of the page 64 of the German passport 71 can be appropriately captured.

### Configuration of Image Processing System

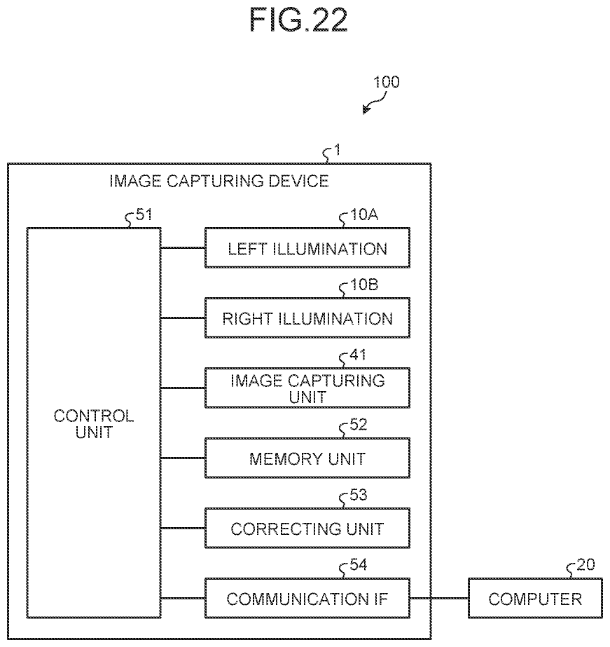

FIG. 22 is a diagram illustrating an exemplary configuration of the image processing system according to the application concerned. With reference to FIC. 22, an image processing system 100 includes the image capturing device 1 and a computer 20. The image capturing device 1 includes the left illumination 10A, the right illumination 10B, the image capturing unit 41, a control unit 51, a memory unit 52, a correcting unit 53, and a communication interface (IF) 54. The image capturing device 1 is connected to the computer 20 using the communication IF 54 in a wired manner or in a wireless manner. Examples of the hardware meant for implementing the control unit 51 and the correcting unit 53 includes a processor. Moreover, examples of a processor meant for implementing the control unit 51 and the correcting unit 53 include a central processing unit (CPU), a digital signal processor (DSP), and a programmable logic device (PLD). Examples of the hardware meant for implementing the memory unit 52 include a random access memory (RAM) and a flash memory.

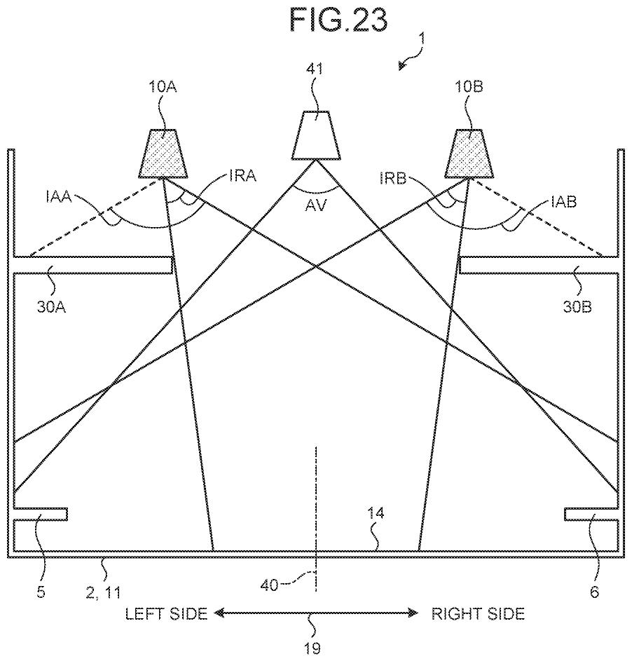

FIG. 23 is a diagram illustrating an exemplary configuration of the image capturing device according to the application concerned. In FIG. 23 is illustrated a front. cross-sectional view of the image capturing device 1. With reference to FIG. 23, the image capturing device 1 includes the mount 2 having the mount main body 11 and the mount surface 14; the left guide member 5; the right guide member 6; the left illumination 10A; the right illumination 10B; and the image capturing unit 41; as well as includes a left shielding member 30A and a right shielding member 30B.

The left shielding member 30A is disposed in between the left guide member 5 and the left illumination 10A; and the right shielding member 30B is disposed in between the right guide member 6 and the right illumination 10B.

The left illumination 10A has an illumination angle IAA, and the right illumination 10B has an illumination angle IAB. However, the irradiation from the left illumination 10A is shielded by the left shielding member 30A, and the irradiation from the right illumination 10B is shielded by the right shielding member 30B. As a result, the actual irradiation angle of the left illumination 10A with respect to the mount surface 14 is restricted to an irradiation angle IRA, and the actual irradiation angle of the right illumination 10B with respect to the mount surface 14 is restricted to an irradiation angle IRB.

Moreover, the image capturing unit 41 has an angle of view AV. However, the angle of view AV is restricted by the left guide member 5 and the right guide member 6. Hence, in the guide member existence region, it becomes difficult to capture a reference image, which is to be used in shading correction, using the image capturing unit 41. In that regard, in the application concerned, a reference image extended up to the guide member existence region (hereinafter, called an “extended reference image”) is generated in the following manner.

### Generation of Extended Reference Image

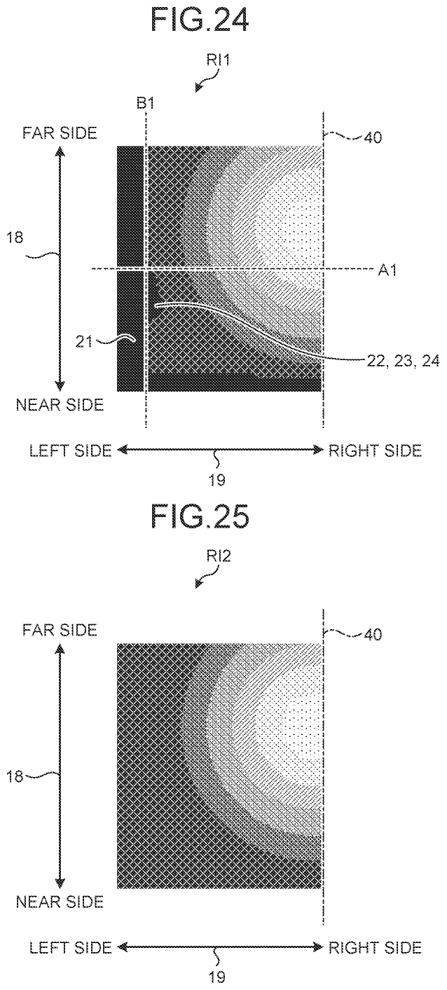

FIGS. 24 to 30 are diagrams for explaining an example of Generating an extended reference image according to the application concerned. Meanwhile, the left illumination 10A and the right illumination 10B are placed in mutually symmetrical manner with respect to the mirror symmetry plane 40, and the left guide member 5 and the right guide member 6 are placed in mutually symmetrical manner with respect to the mirror symmetry plane 40. Hence, the following explanation is given only about the left-side range from the mirror symmetry plane 40 when the right illumination 10B is turned on, and the detailed explanation is not given about the right-side range from the mirror symmetry plane 40 when the left illumination 10A is not turned on.

Firstly, when a reference medium that is white in color and that covers the entire mount surface 14 is placed in the mount 2, the control unit 51 instructs the image capturing unit 41, which has the angle of view AV, to capture, while the right illumination 10B is turned on, an image RI1 (hereinafter, called a “left reference-medium image RI1”) of the reference medium on the left side of the mirror symmetry plane 40 as illustrated in FIG. 24. Then, the control unit 51 sends the left reference-medium image RI1, which is captured by the image capturing unit 41, to the computer 20 using the communication IF 54. Hence, the computer 20 receives the left reference-medium image RI1.

As illustrated in FIG. 24, an image of the left guide member 5 that includes the left-side side guide portion 21, the left holding portion 22, the top left guide portion 23, and the left connection portion 24 (hereinafter, called a “left guide image”) is visible in the left reference-medium image RI1. Hence, with respect to a page image (hereinafter, called a “left page image”) that is captured by the image capturing unit 41 within the left-side range from the mirror symmetry plane 40 when the right illumination 10B is turned on, shading correction can be performed using the image portion of the left reference-medium image RI1 excluding the left guide image. On the other hand, it is difficult to perform shading correction using the left guide image of the left reference-medium image RI1.

Subsequently, as illustrated in FIG. 25, the computer 20 firstly generates an image RI2 (hereinafter, called an “estimated reference image RI2”) that is estimated to be captured by the image capturing unit 41 under the assumption that a white reference medium is present over the entire angle of view AV of the image capturing unit 41 (i.e., over the entire image capturing range of the image capturing unit 41). That is, the computer 20 generates a reference image in which the left guide image is not visible. For example, the computer 20 generates the estimated reference image RI2 based on: the image capturing unit 41; the distance between the left illumination 10A and the mount surface 14; the distance between the right illumination 10B and the mount surface 14; the angle of view AV; and the irradiation angles IRA and IRB.

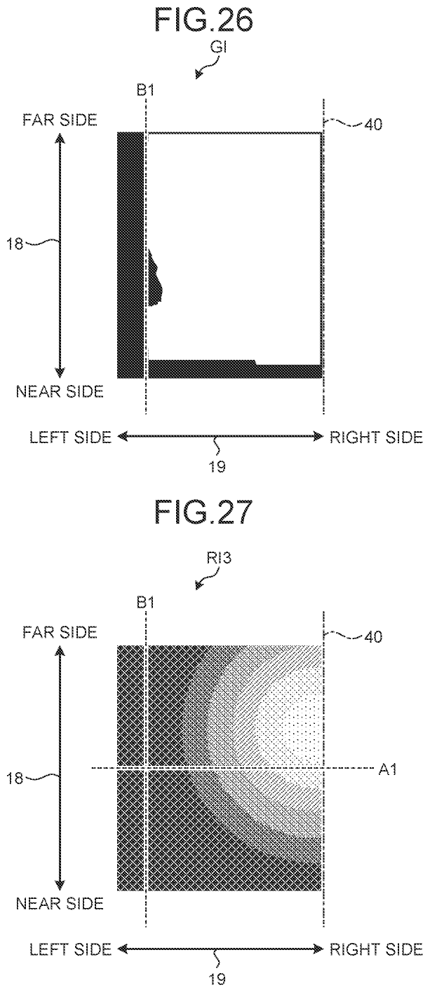

Then, the computer 20 performs shading correction of the left reference-medium image RI1 using the estimated reference image RI2, and generates an image GI (hereinafter, called a “left guide highlighting image G1”) in which the left guide image of the left reference-medium image RI1 is highlighted as illustrated in FIG. 26.

Subsequently, using the left guide highlighting image GI, the computer 20 detects such a region in the left reference-medium image RI1 in which the left guide image is present (hereinafter, called a “left-guide-image existence region”). Then, according to the detected left-guide-image existence region and using an image (hereinafter, called a “left-guide-image nonexistence region image”) of such a region in the left reference-medium image RI1 in which the left guide image is not present (hereinafter, called a “left-guide-image nonexistence region”), the computer 20 corrects the left guide image and obtains an extended reference image RI3 of the left side of the mirror symmetry plane 40 (hereinafter, called a “left extended reference image RI3”) as illustrated in FIG. 27.

For example, the computer 20 substitutes, in the left reference-medium image RI1, the pixels of the left guide image with such pixels from among a plurality of pixels constituting the left-guide-image nonexistence region image which are adjacent to the left-guide-image nonexistence region (hereinafter, called “adjacent pixels”), and obtains the extended reference image RI3 in which the gradation of the adjacent pixels is extended up to the left-guide-image existence region.

In this way, the computer 20 corrects the left reference-medium image RI1 using the estimated reference image RI2, and obtains the left extended reference image RI3. Then, the computer 20 sends the left extended reference image RI3 to the image capturing device 1. In the image capturing device 1, the control unit 51 receives the left extended reference image RI3 using the communication IF 54 and stores it in the memory unit 52.

When shading correction is to be performed with respect to the left page image captured by the image capturing unit 41, the control unit 51 outputs the left page image and the left extended reference image RI3 to the correcting unit 53. Then, the correcting unit 53 corrects the gradation of the left page image based on the left extended reference image RI3, and thus performs shading correction with respect to the left page image.

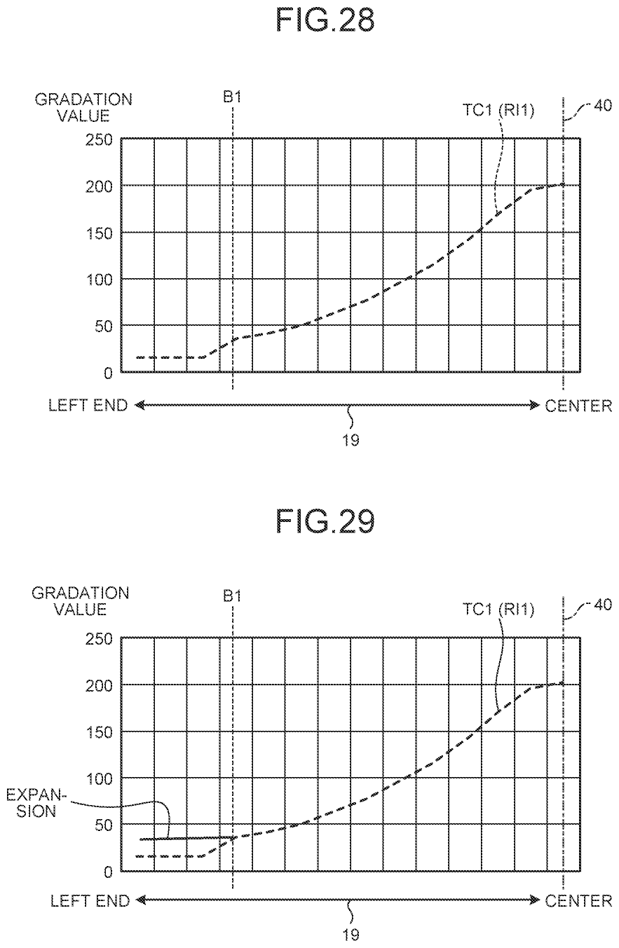

In FIG. 28 is illustrated a tone curve TC1 corresponding to a reference line A1 of the left reference-medium image RI1 (see FIG. 24). Since the left reference-medium image RI1 includes a left guide image, the gradation values in the tone curve TC1 undergo a significant change at a boundary B1 between the left-guide-image existence region and the left-guide-image nonexistence region.

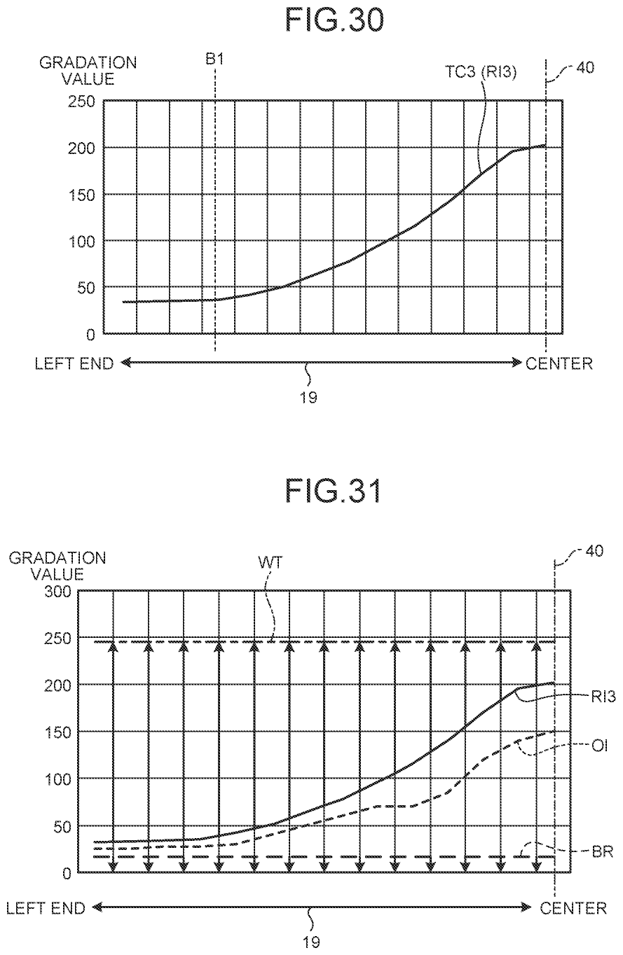

From among the gradation values in the tone curve TC1, the computer 20 extends the gradation values of the adjacent pixels up to the left-guide-image existence region as illustrated in FIG. 29, and obtains the left extended reference image RI3 having a tone curve TC3 as illustrated in FIG. 30.

For example, the computer 20 calculates the gradation value in. the left-guide-image existence region according to Equation (1) given below, and extends the gradation value of the adjacent pixels up to the left-guide-image existence region.

Gradation value in left-guide-image existence region=(slope of tone curve TC1 at few pixels on right side of boundary B1)×(number of pixels from left end of tone curve TC1 to boundary B1)+(gradation value of adjacent pixels) (1)

Meanwhile, when the left illumination 10A is turned on, regarding the left-side range from the mirror symmetry plane 40, in an identical manner to the explanation given above, the image capturing device I captures an image RI1′ (hereinafter, called a “right reference-medium image RI1”) of the reference medium on the right side of the mirror symmetry plane 40; and sends the right reference-medium image RI1′ to the computer 20. Then, using the estimated reference image RI2, the computer 20 corrects the right reference-medium image RI1′, and obtains an extended reference image RI3′ of the right side of the mirror symmetry plane 40 (hereinafter, called a “right extended reference image RI3′”). Subsequently, the computer 20 sends the right extended reference image RI3′, which is obtained in an identical manner to the left extended reference image RI3, to the image capturing device 1. In the image capturing device 1, the control unit 51 receives the right extended reference image RI3′ using the communication IF 54 and stores it in the memory unit 52. When shading correction is to be performed with respect to a page image (hereinafter, called a “right page image”) that is captured by the image capturing unit 41 within the right-side range from the mirror symmetry plane 40 when the left illumination 10A is turned on, the control unit 51 outputs the right page image and the right extended reference image RI3′ to the correcting unit 53. Then, the correcting unit 53 corrects the gradation of the right page image based on the right extended reference image RI3′, and thus performs shading correction with respect to the right page image.

Meanwhile, alternatively, the control unit 51 can cause the image capturing unit 41 to capture a plurality of left reference-medium images RI1. In that case, the computer 20 can average out the pixel-by-pixel gradation. values in the left reference-medium images RI1 among the corresponding pixels in those left reference-medium images RI1; can correct a reference medium image, which includes the pixels having the averaged-out gradation values, using the estimated reference image RI2; and can obtain the left extended reference image RI3. In an identical manner, the control unit 51 can cause the image capturing unit 41 to capture a plurality of right reference-medium images RI1″. In that case, the computer 20 can average out the pixel-by-pixel gradation values in the right reference-medium images RI1′ among the corresponding pixels in those right reference-medium images RI1′; can correct a reference medium image, which includes the pixels having the averaged-out gradation values, using the estimated reference image RI2; and can obtain the right extended reference image RI3′.

Meanwhile, as far as generating an extended reference image in the computer 20 is concerned, some or all of the operations can be implemented by causing the computer 20 to execute a computer program corresponding to the operations. For example, a computer program corresponding to the operations performed in the computer 20 can be stored in the computer 20. Alternatively, for example, a computer program corresponding to the operations performed in the computer 20 can be stored in a program server that is connected to the computer 20 via an arbitrary network, and can be downloaded in the computer 20 for execution. Still alternatively, a computer program corresponding to the operations performed in the computer 20 can be stored in a computer-readable recording medium, and can be read from the recording medium for execution.

### Shading Correction

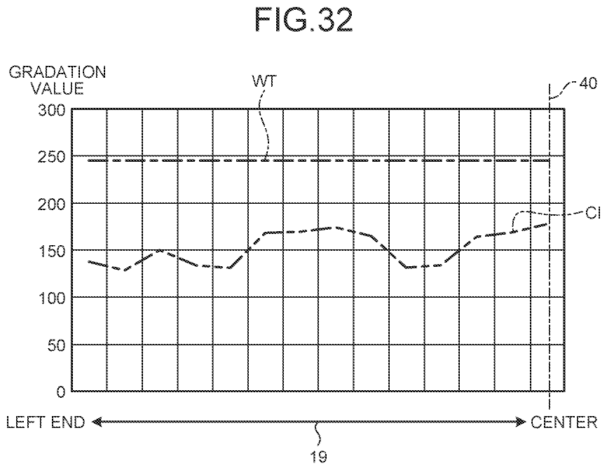

FIGS. 31 and 32 are diagrams for explaining an example of shading correction performed according to the application concerned. As illustrated in FIGS. 31 and 32, according to Equation (2) given below, the correcting unit 53 corrects the gradation of a left original image OI, which is the left page image prior to shading correction, based on the gradation of the left extended reference image RI3, and thus performs shading correction with. respect to the left original image OI; and obtains a left corrected image CI formed as a result of performing shading correction of the left original image OI.

Gradation value of left corrected image CI=((gradation value of left original image OI)−(gradation value of black reference image BR))×(gradation value of white target WT)÷((gradation value of left extended reference image RI3)−(gradation value of black reference image BR)) (2)

In an identical manner to the shading correction performed with respect to the left original OI, the correcting unit 53 corrects the gradation of a right original image OI′, which is the right page image prior to shading correction, based on the gradation of the right extended reference image RI3′, and thus performs shading correction with respect to the right original OI′; and obtains a right corrected image CI′ formed as a result of performing shading correction of the right original image OI′.

Then, the correcting unit 53 synthesizes the left corrected image CI and the right corrected image CI′ around the mirror symmetry plane 40, and obtains a page image in which shading correction has been performed over the entire image capturing range of the image capturing unit 41.

Till now, the explanation was given about the embodiment of the application concerned.

As explained above, an image capturing device according to the application concerned (the image capturing device 1 according to the embodiment) includes a mount (the mount 2 according to the embodiment), an image capturing unit (the image capturing unit 41 according to the embodiment), a memory unit (the memory unit 52 according to the embodiment), and a correcting unit (the correcting unit 53 according to the embodiment). On the mount, an image-capturing target medium is placed. The image capturing unit is disposed to face the mount; and captures an image of the image-capturing target medium, which is placed on the mount, from above of the image-capturing target medium. The memory unit stores a third reference image (the extended reference image according to the application concerned) that is obtained when a first reference image (the reference medium image according to the embodiment), which is a reference image captured by the image capturing unit, is corrected using a second reference image (the estimated reference image) that is estimated to be captured by the image capturing unit under the assumption that a reference medium is present over the entire image capturing range of the image capturing unit. The correcting unit corrects the gradation of the image of the image-capturing target medium, which is captured by the image capturing unit, based on the gradation of the third reference image.

For example, the image capturing device according to the application concerned includes holding members (the left guide member 5 and the right guide member 6 according to the embodiment) that are placed in between the mount and the image capturing unit, and that hold the image-capturing target medium toward the mount and cover some part of the top surface of the image-capturing target medium from above of the image-capturing target medium. In that case, the second reference image represents an image captured by the image capturing unit when it is assumed that the holding members are not present within the image capturing range.

Moreover, for example, the image capturing device according to the application concerned includes wall portions (the left-side side guide portion 21 and the right-side side guide portions 31 according to the embodiment) that are disposed to remain upright with respect to the mount. In that case, the second reference image represents an image captured by the image capturing unit when it is assumed that the wall members are not present within the image capturing range.

In this way, the gradation of the image of the image-capturing target medium is corrected based on the gradation of the third reference image. With that, shading correction of the image of the image capturing target medium can be performed in an accurate manner.

Furthermore, the memory unit stores the third reference image that is obtained as a result of correcting the gradation of the pixels of the first reference image.

Thus, the third reference image can be obtained from the first reference image in an efficient manner.

Moreover, as the first reference image, a reference image is used that has the gradation values obtained when pixel-by-pixel gradation values in a plurality of first reference images are averaged out among the corresponding pixels in those first reference images.

As a result, it becomes possible to reduce the white noise in the first reference image.

According to the application concerned, it becomes possible to accurately perform shading correction with respect to an image captured by an image capturing device.

Although the present disclosure has been described with respect to specific embodiments for a complete and clear disclosure, the appended claims are not to be thus limited but are to be construed as embodying all modifications and alternative constructions that may occur to one skilled is the art that fairly fall within the basic teaching herein set forth.

What is claimed is:

1. An image capturing device comprising:
a mount on which a medium is placed;
an imager disposed to face the mount and configured to capture an image of the medium, which is placed on the mount, from above of the medium;
a memory configured to store a third reference image which is obtained when a first reference image, which is a reference image captured by the imager, is corrected using a second reference image, which is estimated to be captured by the imager under assumption that a reference medium is present over entire image capturing range of the imager; and
a processor configured to correct gradation of the image of the medium, which is captured by the imager, based on gradation of the third reference image.

2. The image capturing device according to claim 1, wherein the memory stores the third reference image that is obtained as a result of correcting gradation of pixels of the first reference image.

3. The image capturing device according to claim 1, wherein, as the first reference image, a reference image is used that has gradation values obtained when pixel-by-pixel gradation values in a plurality of first reference images are averaged out among corresponding pixels in the plurality of first reference images.

4. The image capturing device according to claim 1, further comprising a holder
disposed between the mount and the imager,
configured to hold the medium toward the mount, and
configured to partially cover some part of top surface of the medium from above of the medium, wherein
the second reference image represents an image estimated to be captured by the imager under assumption that the holder is not present within the image capturing range.

5. The image capturing device according to claim 1, further comprising a wall portion disposed to remain upright with respect to the mount, wherein
the second reference image represents an image estimated to be captured by the imager under assumption that the wall portion is not present within the image capturing range.

6. A reference image generation method for generating a reference image that is used in an image capturing device which includes
a mount on which a medium is placed, and
an imager disposed to face the mount and configured to capture an image of the medium, which is placed on the mount, from above of the medium,
the reference image generation method comprising:
obtaining a first reference image representing a reference image captured by the imager; and
generating that includes
correcting the first reference image using a second reference image which is estimated to be captured by the imager under assumption that a reference medium is present over entire image capturing range of the imager, and
generating a third reference image that is used in correcting gradation of the image of the medium which is captured by the imager.

7. A computer program product having a computer readable medium including a reference image generation program, wherein the reference image generation program, when executed by a computer, which includes
a mount on which a medium is placed, and
an imager disposed to face the mount and configured to capture an image of the medium, which is placed on the mount, from above of the medium,
causes the computer to perform:
obtaining a first reference image representing a reference image captured by the imager; and
generating that includes
correcting the first reference image using a second reference image which is estimated to be captured by the imager under assumption that a reference medium is present over entire image capturing range of the imager, and
generating a third reference image that is used in correcting gradation of the image of the medium which is captured by the imager.
